(19) United States
(12) Patent Application Publication
(10) Pub. No.: US 2021/0025540 A1
(43) Pub. Date: Jan. 28, 2021

(54) DECORATIVE WOODEN FRAME FOR DISPLAY AND DISPLAY DEVICE

(71) Applicant: BOE Technology Group Co., Ltd., Beijing (CN)

(72) Inventor: Deli FANG, Beijing (CN)

(21) Appl. No.: 16/621,344

(22) PCT Filed: Mar. 26, 2019
(86) PCT No.: PCT/CN2019/079753

§ 371 Date: Dec. 11, 2019

(30) Foreign Application Priority Data
May 7, 2018 (CN) 201820672547.X

(51) Int. Cl. F16M 11/04; G06F 1/18; G06F 1/16

(52) U.S. Cl. CPC F16M 11/04; G06F 1/1601; G06F 1/181

(57) ABSTRACT

The present disclosure relates to the technical field of display, and a decorative wooden frame for a display and a display device are disclosed. The decorative wooden frame for a display comprises a plurality of borders, and an inner side of at least one of the borders is provided with a groove for engaging with a hook on the display; wherein the inner surface of the groove includes: a contact surface for abutting against an engaging surface of the hook, and an inclined surface at a set inclined angle with respect to the contact surface, the inclined angle being greater than 0 degree and less than 90 degrees.

### CROSS-REFERENCE OF RELATED APPLICATIONS

The present application is a US National Stage of International Application No. PCT/CN2019/079753, filed Mar. 26, 2019, which claims the priority from Chinese Patent Application No. 201820672547.X, filed with the Chinese Patent Office on May 7, 2018 and entitled “a display wood frame and a display device”, which is hereby incorporated by reference in its entirety.

### FIELD

The disclosure relates to the field of display technologies and particularly to a display wood frame and a display device.

### BACKGROUND

The display wood frame is a structure for decorating and fixing a display, and the inside of the wood frame is provided with a clamping slot for clamping the display. At present, the clamping slot is generally a concave groove which has drawbacks such as difficult processing, difficult polishing and the like.

### SUMMARY

The disclosure discloses a display wood frame, including: a plurality of borders, the inside of at least one of the plurality of borders being provided with a clamping slot for clamping with a clamping hook on a display; an internal surface of the clamping slot including: a contact surface for leaning against a clamping surface of the clamping hook, and an inclined surface having a set included angle with respect to the contact surface, the included angle being greater than 0 degree and less than 90 degrees.

For the above-mentioned display wood frame, the internal surface of the clamping slot thereof includes the contact surface and the inclined surface, where the included angle between the contact surface and the inclined surface is greater than 0 degree and less than 90 degrees. Thus, the processing section of the clamping slot (the section parallel to the opening of the clamping slot) is larger, so the clamping slot is easier to be processed and polished, and the processing efficiency and the surface flatness of the display wood frame may be increased effectively. Furthermore, the inclined surface of the clamping slot structure also has a certain guiding function, and may improve the convenience of the clamping operation between the display wood frame and the display.

In an optional embodiment, the included angle is 45-60 degrees.

In an optional embodiment, the clamping slot is a straight slot running through along the extending direction of the plurality of borders.

In an optional embodiment, the plurality of borders are provided with a plurality of clamping slots, and individual clamping slots of a same border are independent from each other.

In an optional embodiment, the inclined surface is connected with the contact surface via a chamfer.

In an optional embodiment, the inclined surface is connected with the contact surface via a plane.

In an optional embodiment, the clamping slot is a crescent slot.

In an optional embodiment, the inclined surface of the clamping slot is a plane.

In an optional embodiment, the inclined surface of the clamping slot is a camber surface sunk towards a side far from the contact surface.

In an optional embodiment, the contact surface of the clamping slot is a plane.

A display device includes a display and the display wood frame described in any one of the technical solutions described above, where the display is located in the display wood frame, a front frame of the display is provided with the clamping hook, and the clamping slot on the display wood frame clamp with the clamping hook on the front frame of the display.

In an optional embodiment, the front frame of the display includes two long frames arranged symmetrically, and each of the long frames being provided with two clamping hooks.

In an optional embodiment, the plurality of borders of the display wood frame include the crescent slots in one-to-one correspondence to the clamping hooks; and each crescent slot clamps with its corresponding clamping hook.

### BRIEF DESCRIPTION OF THE DRAWINGS

FIG. 1 is a schematic diagram of a partial cross-section of a display wood frame provided by an embodiment of the disclosure.

FIG. 2 is a schematic diagram of a partial cross-section of a display wood frame provided by another embodiment of the disclosure.

FIG. 3 is a schematic diagram of a border of a display wood frame provided by an embodiment of the disclosure.

FIG. 4 is a schematic diagram of a border of a display wood frame provided by another embodiment of the disclosure.

FIG. 5 is a structural schematic diagram of the matching of the clamping slot of a display wood frame with the clamping hook of the display provided by an embodiment of the disclosure.

FIG. 6 is a structural schematic diagram of a display device provided by an embodiment of the disclosure.

### DETAILED DESCRIPTION

The technical solutions in the embodiments of the disclosure will be described clearly and completely below in combination with the accompanying drawings in the embodiments of the disclosure. Obviously the described embodiments are only a part of the embodiments of the disclosure but not all the embodiments. Based upon the embodiments in the disclosure, all of other embodiments obtained by those ordinary skilled in the art without creative work pertain to the protection scope of the disclosure.

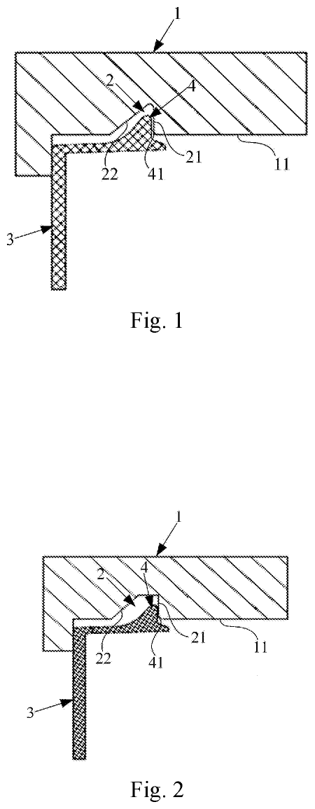

Please refer to FIGS. 1 to 6.

As shown in FIGS. 1 to 6, an embodiment of the disclosure provides a display wood frame which includes a plurality of borders 1, the inside of at least one border 1 being provided with a clamping slot 2 for clamping with a clamping hook 4 on a display 5. The internal surface of the clamping slot 2 includes: a contact surface 21 for leaning against a clamping surface 41 of the clamping hook 4, and an inclined surface 22 having a set included angle with respect to the contact surface 21. Specifically, the above-mentioned included angle is greater than 0 degree and less than 90 degrees.

For the above-mentioned display wood frame, the internal surface of the clamping slot 2 thereof includes the contact surface 21 and the inclined surface 22. The included angle between the contact surface 21 and the inclined surface 22 is greater than 0 degree and less than 90 degrees. Thus, the processing section of the clamping slot 2 (the section parallel to the opening of the clamping slot 2) is larger, so the clamping slot 2 is easier to be processed and polished, and the processing efficiency and the surface flatness of the display wood frame can be increased effectively. Furthermore, the inclined surface 22 of the structure of the clamping slot 2 also has a certain guiding function, and can improve the convenience of the clamping operation between the display wood frame and the display.

As shown in FIGS. 1 and 2 and in a specific embodiment, the contact surface 21 of the clamping slot 2 intersects with the inner side face 11 of the border 1 where the clamping slot 2 is located. The inclined surface 22 of the clamping slot 2 also intersects with the inner side face 11 of the border 1 where the clamping slot 2 is located. That is, both of the contact surface 21 and the inclined surface 22 belong to the side faces of the clamping slot 2.

In an optional embodiment, the contact surface 21 of the clamping slot 2 is perpendicular to the inner side face 11 of the border 1 where the clamping slot 2 is located. The contact surface 21 not only can ensure the reliability of the clamping with the clamping hook 4, but also can facilitate the cancellation of the clamping relationship.

In an optional embodiment, the included angle between the contact surface 21 and the inclined surface 22 of the clamping slot 2 is 45-60 degrees. Specifically, for example, the included angle is 60 degrees.

In an optional embodiment, the contact surface 21 of the clamping slot 2 may be a plane, and the inclined surface 22 of the clamping slot 2 is also a plane. At that time, the section of the clamping slot 2 perpendicular to the contact surface 21 and the inclined surface 22 may be of a triangle or right trapezoid.

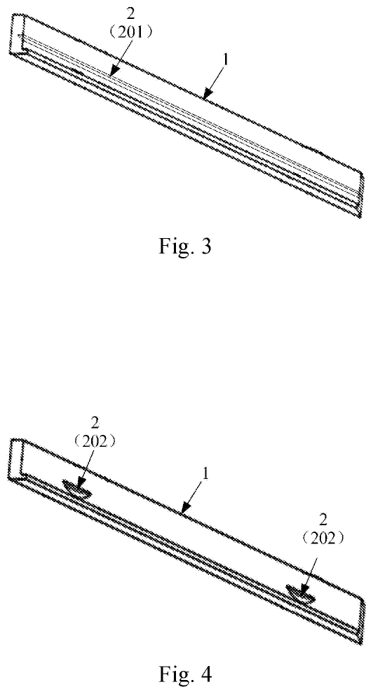

As shown in FIG. 3 and in a specific embodiment, the clamping slot 2 can be a straight slot 201 running through along the extending direction of the borders 1. The processing difficulty of the straight slot 201 is lower, and the processing efficiency can be increased.

As shown in FIG. 4 and in a specific embodiment, the borders 1 are provided with a plurality of clamping slots 2, and the individual clamping slots 2 of the same border 1 are independent from each other, that is, the border 1 is provided with the clamping slots 2 only in the partial positions, but not the straight slot running through along the extending direction of the border 1, which can increase the strength of the border 1 and reduce the deformation of the wood frame.

As shown in FIG. 1, the inclined surface 22 can specifically be connected with the contact surface 21 via a chamfer. Or, as shown in FIG. 2, the inclined surface 22 is connected with the contact surface 21 via a plane.

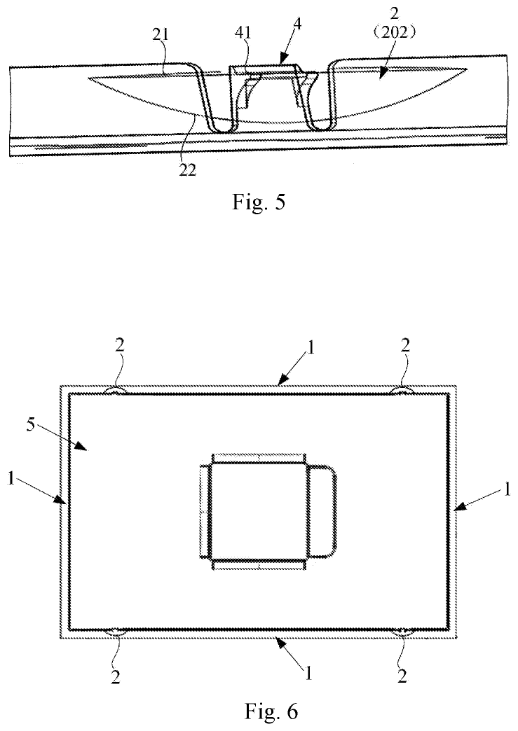

As shown in FIGS. 4 and 5 and in another specific embodiment, the contact surface 21 of the clamping slot 2 is a plane, and the inclined surface 22 of the clamping slot 2 is a camber surface, where the camber surface may specifically be a camber surface sunk towards the side far from the contact surface.

Optionally, the clamping slot 2 can be a crescent slot 202, that is, the processing section of the clamping slot 2 is of a crescent shape. The processing section of the crescent slot 202 is relatively large while the slotting size is relatively small, thus facilitating the processing and polishing, and also increasing the overall strength of the wood frame. Moreover, the difficulty of the processing technology of the crescent slot 202 is also relatively low, which can increase the processing efficiency.

As shown in FIGS. 1 to 6, an embodiment of the disclosure further provides a display device, which includes a display 5 and the display wood frame described in any one of the technical solutions described above; wherein the display 5 is located in the display wood frame, a front frame 3 of the display 5 is provided with a clamping hook 4, and a clamping slot 2 on the display wood frame clamps with the clamping hook 4 on the front frame 3 of the display.

In a specific embodiment, the front frame 3 of the display includes two long frames arranged symmetrically, each long frame being provided with two clamping hooks 4.

In an optional embodiment, the borders 1 of the display wood frame are provided with the crescent slots 202 in one-to-one correspondence to the clamping hooks 4; and each crescent slot 202 clamps with its corresponding clamping hook 4.

In another optional embodiment, each of two borders 1 of the display wood frame matching with the two long frames of the front frame 3 is provided with the straight slots 201; and the two clamping hook 4 on each long frame clamp with the straight slots 201 on the corresponding border 1 simultaneously.

Evidently those skilled in the art can make various modifications and variations to the embodiments of the disclosure without departing from the spirit and scope of the disclosure. Thus the disclosure is also intended to encompass these modifications and variations to the disclosure as long as these modifications and variations come into the scope of the claims of the disclosure and their equivalents.

1. A display device comprising:
a display; and
a display wood frame, comprising a plurality of borders, and surrounding the display,
wherein
the inside of at least one of the plurality of borders being is provided with a clamping slot for clamping with a clamping hook on a display;
an internal surface of the clamping slot comprises: a contact surface for leaning against a clamping surface of the clamping hook, and an inclined surface having a set included angle with respect to the contact surface, wherein the included angle is greater than 0 degree and less than 90 degrees; and
a front frame of the display is provided with the clamping hook, and the clamping slot on the display wood frame clamps with the clamping hook on the front frame of the display.

2. The display device according to claim 1, wherein the included angle is 45-60 degrees.

3. The display device according to claim 1, wherein the clamping slot is a straight slot running through along an extending direction of the plurality of borders.

4. The display device according to claim 1, wherein the plurality of borders are provided with a plurality of clamping slots, and individual clamping slots of a same border are independent from each other.

5. The display device according to claim 1, wherein the inclined surface is connected with the contact surface via a chamfer.

6. The display device according to claim 1, wherein the inclined surface is connected with the contact surface via a plane.

7. The display device according to claim 1, wherein the clamping slot is a crescent slot.

8. The display device according to claim 1, wherein the inclined surface of the clamping slot is a plane.

9. The display device according to claim 1, wherein the inclined surface of the clamping slot is a camber surface sunk towards a side far from the contact surface.

10. The display device according to claim 1, wherein the contact surface of the clamping slot is a plane.

11. (canceled)

12. The display device according to claim 1, wherein the front frame of the display comprises two long frames arranged symmetrically, and each of the long frames being provided with two clamping hooks.

13. The display device according to claim 12, wherein the plurality of borders of the display wood frame comprise crescent slots in one-to-one correspondence to the clamping hooks; and each crescent slot clamps with its corresponding clamping hook.
